(19) United States
(12) Patent Application Publication
(10) Pub. No.: US 2017/0046785 A1
(43) Pub. Date: Feb. 16, 2017

(54) MULTI-USER SYNCHRONIZED DRIVER PROFICIENCY MONITOR AND ALERT SYSTEM

(71) Applicant: Alta Development, Inc., Cabin John, MD (US)

(72) Inventors: Matthew Herrington, Cabin John, MD (US); Shannon Hawkins, Cabin John, MD (US)

(21) Appl. No.: 15/234,946

(22) Filed: Aug. 11, 2016

Related U.S. Application Data
(60) Provisional application No. 62/203,450, filed on Aug. 11, 2015.

(51) Int. Cl. G06Q 40/08

(52) U.S. Cl. CPC G06Q 40/08

(57) ABSTRACT

Methods and systems for measuring one or more metrics of driving proficiency, analyzing the measured metric of driving proficiency, and transmitting a report including the analysis of the measured metric of driving proficiency are described. The metric of driving proficiency can be, e.g., speed, acceleration, deceleration, or weaving between lanes. The analysis can include comparing the measured metric of driving proficiency against data related to the measured metric of driving proficiency accessed from a database. The methods and systems described can be used to, e.g., monitor the driving of a teen driver. Other features and aspects are described herein.

### CROSS-REFERENCE TO RELATED APPLICATION(S)

This application claims priority to U.S. Provisional Application No. 62/203,450 filed Aug. 11, 2015, the entirety of which is hereby incorporated by reference.

### BACKGROUND

Motor vehicle accidents and fatal motor vehicle crashes occur at significantly higher rates during the first two years after a teenager first receives his or her driver's license than during almost any other time of a driver's lifetime. This high incident of motor vehicle accidents is often attributed to the process by which teenagers obtain a driver's license and are acclimatized to driving. For example, a typical process towards obtaining a driver's license requires relatively little supervised driving time. As a result, a critical gap in the driver maturation process exists, during which teen drivers are at high risk for motor vehicle accidents and fatalities.

One of the most significant factors in teenager-related motor vehicle accidents is speeding. Again, without appropriate levels of supervision before being given driving independence via a driver's license, many teenagers fail to learn the increased risks that come with speeding and excessive acceleration and deceleration. The rate of motor vehicle accidents lowers significantly once driver's turn 18, but 16 and 17 year old drivers are effectively left without any viable choices when it comes to safely maturing as a driver during these critical first two years of driving independence.

Accordingly, a need exists for a system that can provide teenaged drivers with the training and supervision required to improve driving skills during the critical first years of driving while still giving teenaged driver's some level of driving independence.

### BRIEF DESCRIPTION OF THE DRAWINGS

FIG. 1 is a block diagram illustrating components of a suitable computing environment according to various embodiments described herein.

FIG. 2 is a block diagram illustrating components of a driving proficiency monitoring system according to various embodiments described herein.

FIG. 3 is a flow diagram illustrating a method for monitoring, analyzing and reporting on driving proficiency according to various embodiments described herein.

FIGS. 4A and 4B are display diagram illustrating driving proficiency reports according to various embodiments described herein.

### DETAILED DESCRIPTION

### Overview

Systems and methods for monitoring, analyzing, and reporting on one or more metric of driving proficiency are described.

In some embodiments, the systems and methods described herein measure one or more metric of driving proficiency during operation of a motor vehicle, access a database including data related to the metric of driving proficiency being measured during operation of the vehicle, analyze the measurements of driving proficiency relative to the data accessed from the database to determine whether a driving proficiency violation has occurred, and wirelessly transmit a report to a remote location, wherein the report includes information regarding any potential driving proficiency violations.

For example, the systems and methods described herein may measure speed of a vehicle and simultaneously or sequentially access, via a database, speed limit information for the road on which the vehicle is travelling. The systems and methods may then determine if the measured speed of the vehicle exceeds the speed limit. Any speed limit violations can then be included in a report generated by the system and transmitted to a remote location by the system.

In some embodiments, the methods and systems described herein can monitor, analyze and report of metrics of driving proficiency regardless of the person operating the motor vehicle. In some embodiments, the systems and methods are carried out using an application running on a mobile device and the driving proficiency metric is measured, analyzed and reported on so long as the mobile device is present within the motor vehicle during operation. In other words, the mobile device need not be the driver's mobile device in order for driving proficiency to be monitored. This thereby allows motor vehicle monitoring even when a person running the application on a mobile device is merely a passenger in the motor vehicle.

In some embodiments, the methods and systems described herein include anti-tampering functionality. In some embodiments, anti-tampering functionality takes the form of a report that is generated and transmitted to a remote location when an action is taken that would prevent the methods and systems from monitoring metrics of driving proficiency (e.g., turning off a mobile device on which an application monitoring driving proficiency metrics is running, deleting an application monitoring driving proficiency metrics, etc.). In some embodiments, the systems and methods require authorization to delete any data previously measured regarding driving proficiency metrics.

### Suitable System

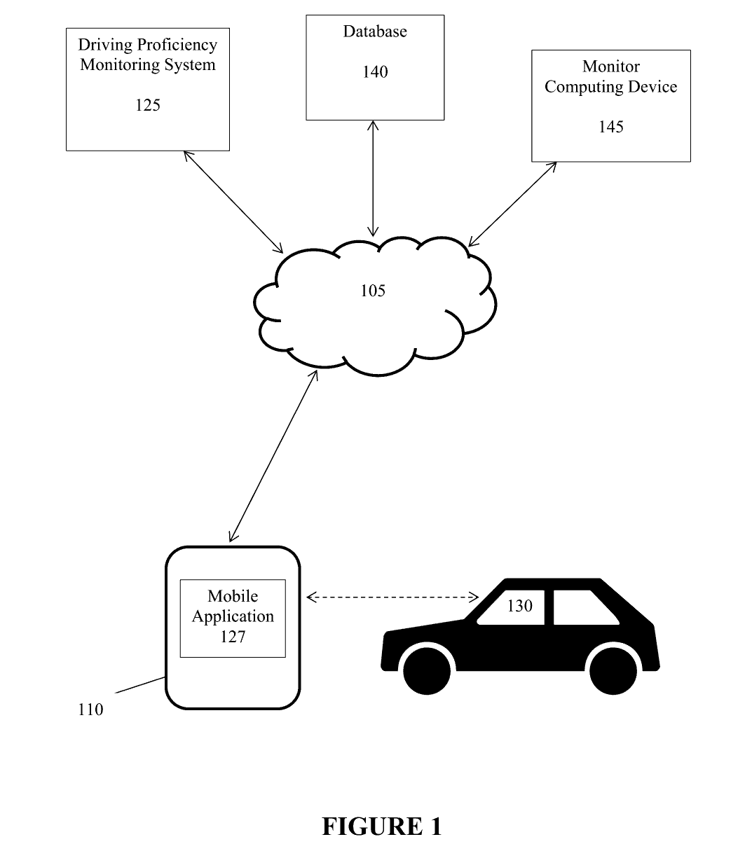

As described herein, systems and methods for monitoring, analyzing and reporting on driving proficiency are described. FIG. 1 illustrates components of a suitable computing environment 100 in which a driving proficiency monitoring system 125 may be supported and/or implemented. The computing environment 100 includes a mobile device 110, such as a mobile phone or tablet computer that supports and provides applications (e.g., “apps”) to a user of the mobile device 110. For example, the mobile device 110 may include a mobile application 127 provided by and/or associated with the driving proficiency system 125. The mobile application 127 may communicate with other mobile applications (e.g., a mapping application) installed on the mobile device 110, core software included as part of an operating system of the mobile device 110 (e.g., APIs for accessing accelerometer and compass data), the driving proficiency monitoring system 125, one or more databases 140 (e.g., a geographic information system), and/or one or more remote monitor computing devices 145, over a network 105, such as the internet or other wireless or telecommunication networks. The motor vehicle 130 may be any type of motor vehicle, and the mobile device 110 running the mobile application 127 generally resides within the motor vehicle when the driving proficiency monitoring system 125 is in operation.

The mobile device 110 may be a tablet computer, mobile device, smart-phone, net-book, mobile GPS navigation device, vehicle-mounted computing system, or any other device that supports, presents, and/or displays apps via a user interface, such as a touch-screen, of the device 110. The mobile device 110 includes various hardware and/or software components in order to provide such functionality. For example, the mobile device 110 includes various human interface components, device components, memory, and so on.

The mobile device 110 may include a touch-screen or other input component that provides input to a processor. The touch-screen may include or communicate with a hardware controller, such as a touch-screen driver, that interprets raw signals received from the touch-screen and transmits information associated with a contact event (e.g., a pressing of an app via the touch-screen), to the processor. The touch-screen may be part of a display, such as a touch-screen display, a flat panel display, an electronic ink display, a head-mounted display, a liquid crystal display, a light-emitting diode display, a plasma panel display, an electro-luminescent display, a vacuum fluorescent display, a digital projector, a laser projector, a heads-up display, and so on. The mobile device 110 may include other interface components, such as a speaker that provides appropriate auditory signals to assist a user in navigating a touch-screen, and so on.

The mobile device 110 may include various device components, such as sensors (e.g., GPS or other location determination sensor/receiver, motion sensor, gyroscope, accelerometers, compass, light sensor, thermometer, and so on), removable storage devices (e.g., SIM cards), cameras and other video capture devices, microphones and other audio capture devices, communication devices (e.g., Bluetooth devices, radios, antennas), and so on.

The mobile device 110 may include a processor that communicates with data or applications stored in the memory of the device 110, which may include a combination of temporary and/or permanent storage, and both read-only and writable memory (random access memory or RAM), read-only memory (ROM), writable non-volatile memory such as FLASH memory, hard drives, floppy disks, SIM-based components, and so on. The memory may include various program components or modules, such as an operating system, and various applications, such as applications downloaded to the device 110. For example, the memory may store applications native to the device that perpetually operate on the device (e.g., a keyboard application that provides a virtual keyboard, a text messaging application, and so on) as well as applications that are downloaded by a user and launched by the device (e.g., applications associated with social networking sites, games, and so on).

The memory may store one or more applications associated with a motor vehicle, such as the mobile application 127, which facilitates communication between the mobile device 110 and a database 140, the remote monitor computing device(s) 145, and/or a server supporting the driving proficiency monitoring system 125.

For example, the mobile application 127 may communicate over the network 105 with the database 140, the remote monitor computing device(s) 145, and/or the driving proficiency monitoring system 125. The network 105 may be a Local Area Network (LAN), a Wide Area Network (WAN), the Internet, or other networks capable of facilitating various communications between computing devices.

In some embodiments, the mobile application 127 may communicate directly with various components of the computing environment 100. The mobile device 110 may include various communication components (e.g., Bluetooth) that facilitate short range, near field, and/or other direct or personal area network communications between devices.

The one or more databases 140 that form a part of the computing environment 100 can be any type of accessible database useful for providing information required to monitor and assess driving proficiency. For example, the database 140 may include a geographic information system (GIS) database that provides information regarding government-set speed limits for public roads on which the vehicle 130 travels. Other information, such as weather conditions and road construction projects can also be accessed via relevant databases.

The one or more remote monitor computing devices 145 that form a part of the computing environment can be any type of computing device suitable for receiving and displaying information transmitted by the driving proficiency monitoring system 125. For example, the remote monitor computing device 145 may be a mobile device, a tablet, a laptop computer, or a desktop computer. In some embodiments, the remote monitor computing device 145 includes and runs software capable of communicating with the driving proficiency monitoring system 125 such that information collected by, e.g., the mobile device 110 running the mobile application 127 during operation of a motor vehicle in which the mobile device 110 is located and analyzed by the driving proficiency monitoring system 125 can be transmitted to and displayed on the remote monitor computing device 145. The remote monitor computing device 145 may be located, e.g., at a location remote from motor vehicle whose operation is being monitored via the driving proficiency monitoring system 125. In one example, the remote monitor computing device 145 can be a mobile device or personal computer of a parent or guardian of a teen driver whose driving is being monitored by the system 125. When a teen driver uses the driving proficiency monitoring system 125 during operation of a motor vehicle, the information collected and analyzed by the driving proficiency monitoring system 125 can be transmitted to the computing device 145 of a parent or guardian of the teen driver.

While not illustrated in FIG. 1, the computing environment can further include computing devices that are incorporated into the motor vehicle. In one example, the computing environment further includes a motor vehicle computing device capable of communicating with all of the other components of the computing environment. The motor vehicle computing device can include, for example, computing devices controlling various components of the motor vehicle, such as on-board navigation systems, climate control systems, and sensing equipment. In some embodiments, the sensing equipment (e.g., rear and forward sensors) can be accessed as part of the system to gauge whether a driver is tailgating or being tailgated as part of measuring driving proficiency.

FIG. 1 and the discussion herein provide a brief, general description of a suitable computing environment in which the driving proficiency monitoring system 125 can be supported and implemented. Although not required, aspects of the system are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible computer-readable storage media, such as non-transitory media), including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the system may be distributed over the Internet or over other networks (including wireless networks) or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

### Examples of Monitoring, Analyzing, and Reporting of Driving Proficiency

As described herein, in some embodiments, the driving proficiency monitoring system 125 is configured to measure, analyze, and report on one or more metrics of driving proficiency, such as speed, acceleration, deceleration, and weaving, among other things.

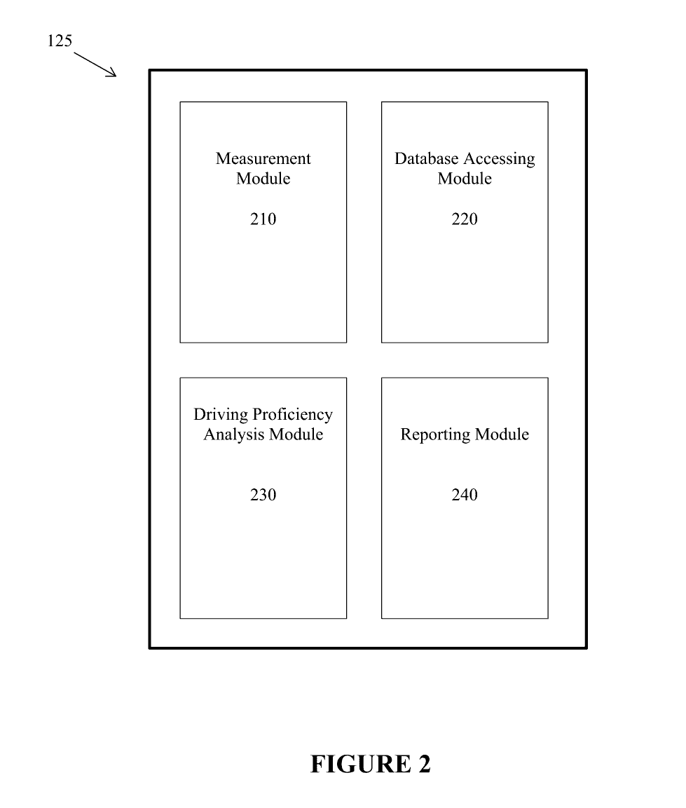

FIG. 2 is a block diagram illustrating components of a driving proficiency monitoring system 125, such as a measurement module 210, a database accessing module 220, a driving proficiency analysis module 230, and a reporting module 240. The driving proficiency monitoring system 125 includes a variety of functional modules. One skilled in the art will appreciate that the functional modules are implemented with a combination of software (e.g., executable instructions, or computer code) and hardware (e.g., at least a memory processor). Accordingly, as used herein, in some embodiments a module is a processor-implemented module and represents a computing device having a processor that is at least temporarily configured and/or programmed by executable instructions stored in memory to perform one or more of the particular functions that are described herein.

In some embodiments, the measurement module 210 is configured and/or programmed to measure one or more metrics of driving proficiency. For example, the measurement module 210 may measure the speed, acceleration, deceleration, and/or weaving of the motor vehicle that is being subjected to driving proficiency monitoring via the driving proficiency monitoring system 125. Measurement of one or more of these metrics may be performed periodically during operation of the motor vehicle (e.g., once every 10 seconds) or continuously during operation of the motor vehicle. The measurement module 210 may carry out measurement of the metric(s) using components of the mobile device 110 running the application 127. For example, a mobile device 127 may be equipped with an accelerometer capable of measuring speed, acceleration and deceleration. The mobile device 127 may also be equipped with GPS functionality capable of measuring speed, side to side movement on a road, such as between lanes (referred to herein as weaving), and route selection (e.g., driving on a national interstate versus on an adjacent surface road). Any of these functionalities may be accessed by the measurement module 210 in order to carry out measurement of one or more metrics of driving proficiency.

In some embodiments, the database accessing module 220 is configured and/or programmed to access one or more databases of information that may be useful for analyzing the driving proficiency metric(s) measured by the measurement module 210. For example, the database accessing module 220 may query and/or access information stored in a local or remote database in order to retrieve and/or access information related to government-imposed speed limits on public roads. Other databases that can be accessed include databases that include predetermined threshold limits for various driving proficiency metrics such as acceleration, deceleration and weaving.

In some embodiments, the driving proficiency analysis module 230 is configured and/or programmed to analyze the measured driving proficiency metrics to thereby determine whether violations are occurring with respect to predetermined compliance values for various driving proficiency metrics. For example, the driving proficiency module 230 may calculate a difference between a measured speed during operation of a motor vehicle and a speed limit for the road on which the motor vehicle is traveling at the time the speed measurement is taken, with the speed limit being obtained via the database accessing module 220. The driving proficiency analysis module 230 may then determine whether the calculated difference exceeds a tolerance value set for the speed driving proficiency metric. Similar analysis can be carried out with respect to, e.g., acceleration, deceleration or weaving. In the case of the these driving proficiency metrics, the measured value may be calculated against a predetermined acceptable acceleration, deceleration or weaving value. In such situations, the analysis module may only need to calculate whether the measured metric exceeds the predetermined acceptable value for the specific driving proficiency metric, rather than compare it against a threshold tolerance value.

In some embodiments, the reporting module 240 is configured and/or programmed to generate a report that includes relevant information derived from the driving proficiency analysis module 230. For example, the driving proficiency analysis module 230 may calculate the instances where the measured speed exceeded the speed limit by more than the tolerance value for speed, at which point the reporting module may prepare and/or transmit a report regarding these three violations. The reporting module 240 may be designed to provide either or both of a local report to be displayed on the mobile device 110 via application 127 and a remote report to be transmitted over, e.g., the network 105 to a remote monitor computing device 145.

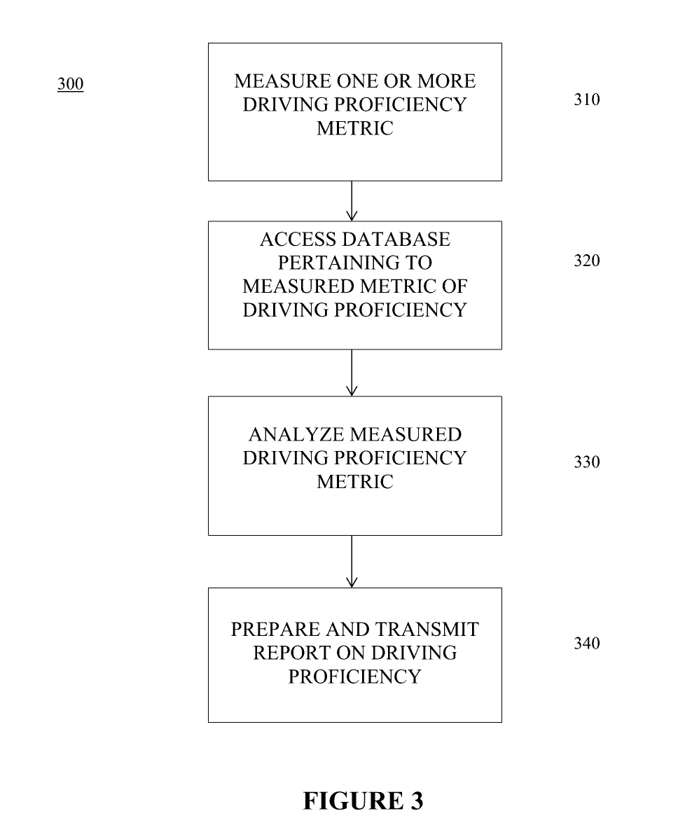

As described herein, in some embodiments, the driving proficiency monitoring system 125 performs methods and processes to determine compliance or lack of compliance with predetermined values for various measured driving proficiency metrics, and reporting on this monitoring. FIG. 3 is a flow diagram illustrating a method 300 for measuring one or more driving proficiency metrics, analyzing the measured data, and producing and/or transmitting a report or reports based on the analysis. The method may be performed by the driving proficiency monitoring system 125, and accordingly, is described hereby merely by reference thereto. It will be appreciated that the method 300 may be performed on any suitable hardware.

In operation 310, the driving proficiency monitoring system 125 measures one or more driving proficiency metric. Non-limiting examples of metrics of driving proficiency that can be measured include speed, acceleration, deceleration, and weaving. The system 125 can be configured to measure one or more metric, and can conduct measurements of any of the one or more metrics at any interval, including continuously during operation of a motor vehicle. The system 125 includes the necessary functionality to measure any of the specific driving proficiency metrics being evaluated. For example, mobile phone 110 running application 127 may be situated within the motor vehicle being operated and evaluated by the system 125, and the mobile phone may include software or other components necessary to measure, e.g., speed, acceleration, deceleration, and/or weaving using an accelerometer and/or GPS positioning included within the mobile phone 110.

In some embodiments, operation 310 is carried out such that measurement of driving proficiency metric(s) automatically begins when operation of a motor vehicle begins (i.e., at the beginning of a trip) and automatically ends when operation of a motor vehicle ends (i.e., at the end of a trip). The ability to begin and end measurements in sync with the beginning and ending of a trip can be tied to the system 125 being able to identify transport within a motor vehicle, such as by identifying speed, acceleration and/or deceleration that is in line with the operation of a motor vehicle and not in line with other modes of transport (i.e., walking, riding a bike, riding a bus, etc.).

Significantly, operation 310 (and subsequently described operations 320, 330, and 340) can be carried out regardless of who is driving a motor vehicle being monitored, so long as the mobile phone 110 running application 127 associated with system 125 is present within the motor vehicle. In this manner, the system 125 can be used to assess driving both when a user/owner of the mobile phone 110 running application 127 is driving the motor vehicle and when the user/owner of the mobile phone 110 is a passenger in a motor vehicle. This feature allows parents and or guardians to ensure safe driving when a teen is driving or when a teen is a passenger in a friend's motor vehicle.

Operation 310 may further include the measuring and monitoring of other devices within a motor vehicle as a means for identifying/estimating the number of people in a vehicle. For example, a mobile phone 110 running application 127 associated with system 125 may include the ability to detect signals emitted by other electronic devices (e.g., Bluetooth signals) within a vicinity of the mobile phone 110, such as via the measuring module 210. The mobile phone 110/measuring module 210 may include the ability to discern different types of devices via their emitted signal so as to be able to differentiate, e.g., mobile phone devices from other types of devices, such as a laptop computer also located in the vicinity of mobile phone 110. Once operation 310 has determined the total number, e.g., mobile phone devices in the vicinity of the mobile phone 110, this measurement may be used to estimate the number of people in the motor vehicle. If the number of people estimated to be in the motor vehicle is higher than a threshold value set for an acceptable number of people in the vehicle, a report can be generated and transmitted altering a parent or guardian to the number of people estimated to be in a motor vehicle.

In operation 320, the driving proficiency monitoring system 125 accesses a database including data pertaining to the metric(s) of driving proficiency being measured in operation 310. For example, system 125 can access data from a database including speed limits for roads on which the motor vehicle is traveling. Accessing this data can be done in conjunction with GPS positioning of the motor vehicle (via, e.g., GPS functionality included in the mobile phone 110) such that the system 125 accesses the speed information pertinent to the road on which the motor vehicle is traveling when speed measurements are being gathered. In some embodiments, the system 125 accesses data from a geographic information system (GIS) database that includes the relevant speed information. The GIS database accessed by the system 125 may include updated data regarding speeds as impacted by, e.g., construction. In this manner, driving proficiency can be measured relative to the real time environment, such as when a speed limit is typically 55 mph, but is reduced to 30 mph while construction is being carried out on the road. Other databases that can be accessed include weather databases to provide real time weather conditions that can also be used to adjust the posted speed limit to a lower tolerance value due to, e.g., rain, snow, etc., and databases related to speed limits in, e.g., school zones which cross reference the time of day to determine if reduced speed limits apply. Adjusting posted speed limits based on weather, school zones, etc., may also provide guidance to new drivers as to strategies for driving safely in such conditions.

When the driving proficiency metric being measured is, for example, acceleration, deceleration or weaving, these metrics are typically judged not against government-set values but by preset values that can be assigned by, e.g., a parent or guardian. Such predetermined values may still be stored in a database accessed by the system 125 as part of operation 320. In such embodiments, the database may be local, such as a database stored within the application 127. The application 127 may include an interface in which these values can be adjusted by a parent or guardian. The database may further include variable preset values that are determined by GPS positioning of the motor vehicle. For example, a first preset value may be assigned for a maximum acceptable acceleration when a motor vehicle is traveling on a surface street, while a second preset value higher than the first preset value may be assigned for a maximum acceptable acceleration when the motor vehicle is on a highway. As such, the accessing of data from the database can be done in conjunction with a GPS positioning component to use the appropriate value based on the location of the motor vehicle.

In operation 330, analysis of the measured driving proficiency metric(s) is performed. In some embodiments, this analysis is performed by running comparisons between the measured driving proficiency metric(s) and data accessed from databases as part of operation 320. For example, a speed measurement taken during operation of a motor vehicle is compared to a speed limit value accessed from databases such as a GIS database. The speed limit value accessed will generally be the speed limit for the road on which the motor vehicle is traveling when the speed measurement is taken. In some embodiments, a difference between the measured speed and the speed limit is calculated. If the measured speed is above the speed limit, then the analysis records a violation. If the measured speed is below or at the speed limit, no violation (or compliance) is recorded. A similar analysis is carried out with respect to other metrics such as acceleration, deceleration, or weaving. However, in the case of acceleration, deceleration, and weaving, the measured values are compared against a preset value assigned for the specific metric (for example, as assigned by a parent or guardian).

Operation 330 may also include a tolerance value associated with the comparison analysis. For example, the comparison of measured speed versus speed limit may be carried out as described previously, but a violation is not automatically recorded if the measured speed is above the speed limit. Instead, the difference between measured speed and speed limit is compared against a tolerance value. If the calculated difference is greater than the tolerance value, than a violation may be recorded. If the calculated difference is less than the tolerance value, then no violation (or compliance) is recorded. This tolerance value allows for a margin above the speed limit (e.g., 5 mph over the speed limit) to be tolerated without incurring a violation. The tolerance value can be assigned by, e.g., a parent or guardian. The tolerance value may also be variable based on the speed limit. For example, a higher tolerance value may be permitted on a highway where speed limits are higher than on a surface street where speed limits are lower.

Tiered tolerance values may be used to detect and report severe violations. For example, an instance where the calculated difference between measured speed and speed limit exceeds a severe tolerance value (which will be higher than a regular tolerance value) may be recorded as a severe violation. Thus, if a speed is measured as 70 mph when the speed limit is 40 mph, and the severe tolerance value is 25, then a severe violation will be recorded since the calculated difference of 30 exceeds the severe tolerance value of 25. As discussed in further detail below, such a severe violation may result in a report being sent immediately to a remote monitor computing device 140 such that real time reporting of severe violations is carried out. Other examples of severe violations that can be detected via tiered tolerance values include exceptional acceleration (potentially indicative of drag racing) and acceleration (potentially indicative of near accident).

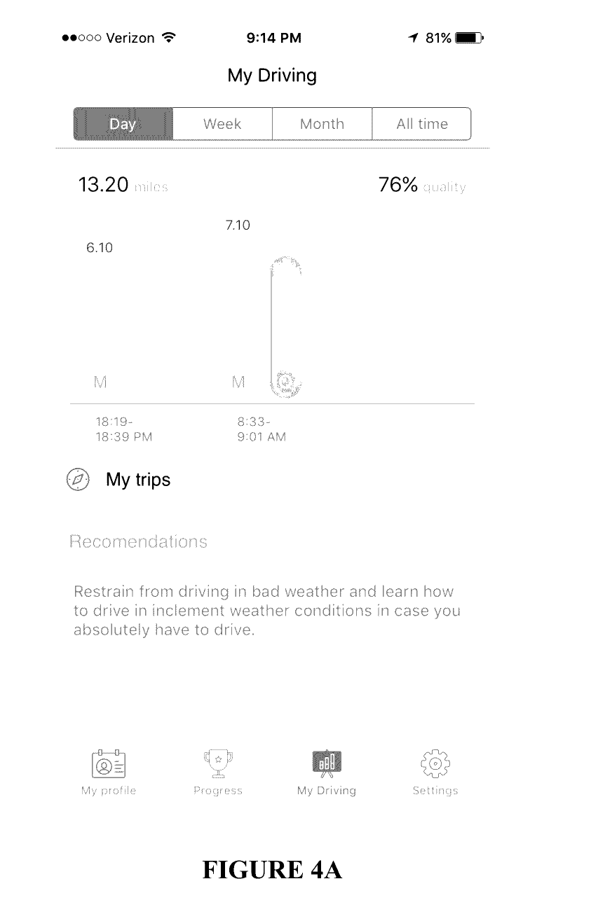

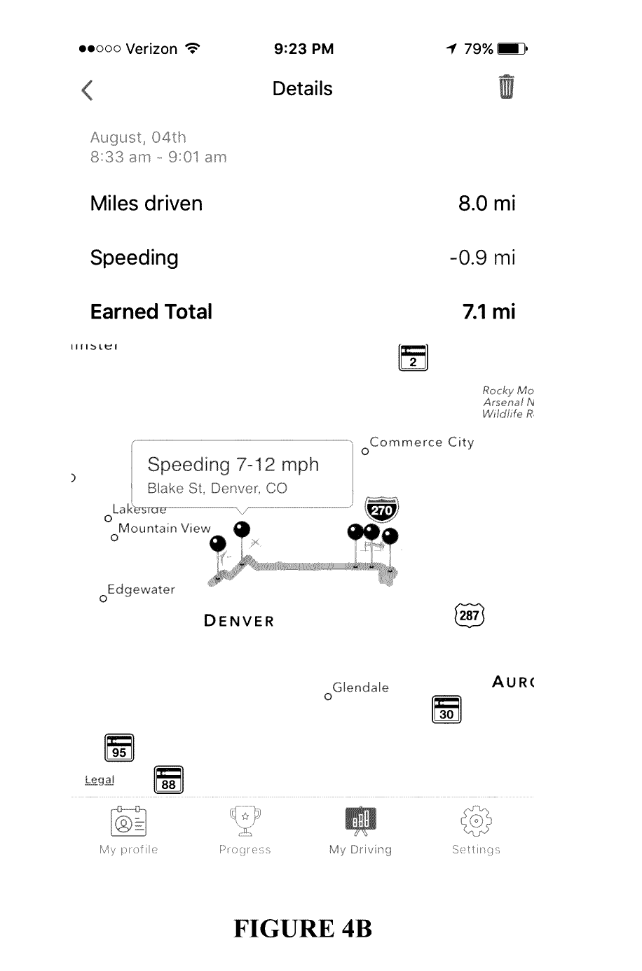

In operation 340, a report on driving proficiency is prepared and transmitted or displayed. The report generally provides information regarding the measured metrics of driving proficiency and how they have been analyzed in operation 330 for compliance. For example, the report can provide information on whether the speed limit was adhered to during operation of a motor vehicle. The specific manner in which the information is displayed is generally not limited. In some embodiments, the report provides a total distance traveled during a trip and a percentage of the total distance traveled while adhering to a speed limit (optionally within a tolerance value). FIG. 4a shows a report organized in this manner. The report is organized on a per trip basis, with a first trip being carried out from 18:19 to 18:39 pm, the total distance traveled being 6.10 miles, and speed limit being adhered to for 63% of the trip. A second trip from 8:33 to 9:01 am is organized in the same manner. In some embodiments, the report provides a map showing the route traveled and where along the route speed limits were not adhered to (optionally within a tolerance value). FIG. 4b shows a report organized in this manner. The report shows the route traveled, including red pins identifying specific instances and locations along the route of speeding violations during the trip. When a red pin is engaged (such as by touching the red pin when the report is displayed on a touch screen), it shows by how much the speed limit was exceeded. The report also shows the total miles driven, the miles during which the speed limit was violated, and how many miles were “earned” (as calculated by subtracting the miles spent speeding from the total miles traveled). “Earned” miles can be used as part of a gamification aspect of the system discussed in further detail below.

Reports such as those discussed above and shown in FIGS. 4A and 4B can be transmitted to a parent, guardian, or other individual at any level of frequency. In some embodiments, the reports are sent at the completion of every trip. Other frequencies can include a digest prepared and transmitted every day or every week, with the report including all data during the day or weekly increment.

Reports such as those discussed above and shown in FIGS. 4A and 4B can also be displayed to the user being monitored by the system 125, such as by displaying the report on a mobile device 110 running an application 127 associated with the system 125. This lets a driver monitor their own progress and driving proficiency in conjunction with the parent, guardian or other individual to whom the reports may be transmitted remotely.

As discussed previously, operation 340 may also include a component where reports are prepare and transmitted in real time when a certain type of violation is committed. In some embodiments, these reports may be generated and transmitted when severe violations occur, such as when a speed limit is exceeded by more than 20 mph or when the acceleration and/or deceleration threshold values are exceeded by a certain value or a certain number of times within a set period of time. Alerts relating to severe violations sent in real time can be sent to remote monitor computing devices, which can include, for example, a mobile phone, and which can be sent in the form a text message alert, email, or mobile operating system notification.

In order to encourage engagement with the system described herein, the reporting operation 340 can include a gamification component. The gamification component can generally set targets which a driver tries to meet in order to earn certain rewards or privileges. As discussed above with respect to FIG. 4B, the gamification component can include attempting to achieve a certain number of “earned” miles, i.e., miles traveled in which speed limits are adhered to. A parent or guardian can set a number of earned miles which must be earned in order to be granted certain privileges, such as the ability to hide a user's location from the parent or guardian using the system to monitor driving proficiency (i.e., turning off GPS monitoring). The gamification component can further include bonus miles awarded for certain tasks completed, such as an extra 5 miles earned when an entire trip is carried out without speeding. Similarly, earned miles can be taken away for certain violations, such as losing 10 miles for each severe speeding violation. The gamification component can further include competitive elements whereby the user competes with other users linked either manually, as “friends,” or through an affinity group such as a high school.

The reporting operation 340 may further include various safeguards against tampering by the driver being monitored. For example, a report can be generated and transmitted when certain actions are undertaken by a user of the application 127 which may be designed to hide violations. The application 127 may include the ability to switch off GPS tracking, and turning off this feature may generate and transmit a report to a remote monitor computing device reporting this action. Similar reports can be generated and transmitted when a mobile device is turned off to avoid measuring of driving proficiency metrics, when a user tries to delete or uninstall an application 127 associated with the system, or when a user tries to delete the record of one or more trips.

The reporting operation 340 may further include functionality that allows for communication between the user and a parent or guardian. A user may request approval to delete, for example, a specific trip. This request will generate a report that includes a request for authorization to delete the specific trip and an explanation for the request. This request is typically transmitted to a remote monitor computing device, where a parent or guardian can approve or deny the request. Such a function may be useful in instances where the user is taking a taxi or riding a bus and the trip should not be recorded as data measuring the user's driving proficiency. In addition, a parent or guardian may communicate with the user regarding a specific trip. Such a function may be useful in instances where the parent or guardian seeks to provide trip-specific feedback.

The reporting operation 340 may further include functionality that provides a summary report of all driving during a specified period, and providing a variety of analytic information including but not limited to whether the driving was at day or night, whether the driving was on highway or surface roads, etc. Such a function may be useful where license-issuing authorities require that the holder of a learner's permit furnish proof of certain quantities and types of driving experience prior to obtaining a license.

The reporting operation 340 may further include functionality that provides a report on metrics of driving proficiency to an insurance company. The insurance company can then use the reported information to assess driving proficiency and determine whether the assessment of driving proficiency predicts in increased or decreased risk of accidents. Such assessments can then be used to adjust insurance rates and premiums.

The system and methods described herein have been described in the context of monitoring a teen driver by a parent or guardian. However, one of ordinary skill in the art will appreciate that the use of the system and methods described herein are not limited to this context. The systems and methods described herein are equally applicable to situations in which, for example, employers may use the system and methods to monitor driving of employees, customers may use the system and methods to monitor taxi drivers, etc. For example, the systems and methods can be used to monitor fleets of vehicles of a specific company (e.g., postal delivery trucks, food delivery vehicles, etc.) and identify the best and worst drivers by aggregating and analyzing reports generated on each individual driver. The systems and method can also be used to monitor a random sample of drivers/vehicles to gather general driving metrics with respect to specific roads or highways. Such data can then be used to adjust driving environments, such as by adding traffic signals. The randomization of information collected in such circumstances can be used to keep specific driver information anonymous. The system and method may also include functionality that allows the system and method to record and report on information pertaining to behavior during erratic driving behavior. For example, the system and method may monitor activities such as talking on a mobile phone, taking a photo on a mobile phone, sending a text on a mobile phone, launching or using an app on a mobile phone, etc. relative to the driving behavior occurring at the time same time to identify potential causes for decreased driving proficiency.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

While many embodiments described above employ software stored on the mobile device, the scripts and other software noted above may be hard coded into the mobile device (e.g. stored in EEPROM, PROM, etc.). Further, the above functionality may be implemented without scripts or other special modules.

The teachings of the system provided herein can be applied to other systems, not necessarily the system described above. The elements and acts of the various embodiments described above can be combined to provide further embodiments.

All of the above patents and applications and other references, including any that may be listed in accompanying filing papers, are incorporated by reference. Aspects of the system can be modified, if necessary, to employ the systems, functions, and concepts of the various references described above to provide yet further embodiments of the system.

These and other changes can be made to the system in light of the above Detailed Description. While the above description details certain embodiments of the system and describes the best mode contemplated, no matter how detailed the above appears in text, the system can be practiced in many ways. Details of the local-based support system may vary considerably in its implementation details, while still being encompassed by the system disclosed herein. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the system are presented below in certain claim forms, the inventors contemplate the various aspects of the system in any number of claim forms. Accordingly, the inventors reserve the right to add additional claims after filing the application to pursue such additional claim forms for other aspects of the system. From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A portable, wireless, data processing system, comprising:
at least one sensor for gathering movement data, wherein the movement data includes acceleration, declaration, speed, or direction;
at least one wireless transceiver for exchanging data with a wireless network;
a portable power supply;
at least one processor coupled to the sensor, the wireless transceiver, and the portable power supply;
at least one memory, coupled to the processor, and storing instructions to be executed by the processor; and
a portable housing for carrying the sensor, wireless transceiver, processor and memory;
wherein the instructions include:
a driving proficiency metric measurement module that receives data from the sensor and measures or determines a metric related to driving proficiency during operation of a motor vehicle in which the portable, wireless, data processing system is located;
a database accessing module that accesses, via the wireless transceiver, data included in a database,
wherein the data pertains to the metric related to driving proficiency being measured or determined by the driving proficiency metric measurement module;
a driving proficiency analysis module that analyzes the metric related to driving proficiency measured or determined by the driving proficiency metric measurement module and the data accessed by the database accessing module and determines whether a driving proficiency violation has occurred during operation of the vehicle; and
a reporting module that prepares a report including any driving proficiency violations determined by the driving proficiency analysis module and wirelessly transmits, via the wireless transceiver, the report to a remote monitor computing device.

2. The system of claim 1, wherein the portable, wireless, data processing system is a cell phone, and wherein the driving proficiency metric measurement module is configured to measure or analyze speed, acceleration, deceleration and weaving during operation of the motor vehicle.

3. The system of claim 1, wherein the driving proficiency metric measurement module is configured to measure speed of the motor vehicle, and the database accessing module is configured to access speed limit information from a remote geographic information system.

4. The system of claim 1, wherein the driving proficiency metric measurement module is configured to measure the metric related to driving proficiency during operation of the vehicle regardless of who is driving the motor vehicle.

5. The system of claim 1, wherein the reporting module is configured to wirelessly transmit a report to the remote monitor computing device when an action is taken that would prevent the driving proficiency metric measurement module from measuring the metric of driving proficiency.

6. The system of claim 1, wherein the reporting module is configured to wirelessly transmit the report to the remote monitor computing device when an attempt to delete data relating to a measurement of a metric of driving proficiency occurs.

7. The system of claim 6, wherein the report includes a request to authorize or deny the attempt to delete data.

8. A non-transitory computer-readable storage medium whose contents, when executed by a mobile application supported by a mobile device, cause the mobile application to perform operations, comprising:
measuring a metric of driving proficiency during operation of a motor vehicle;
accessing a database including data related to the metric of driving proficiency being measured during operation of the vehicle;
analyzing the measured metric of driving proficiency relative to the data accessed from the database; and
wireless transmitting a report to a remote monitor computing device, the reporting including the analysis of the measured metric of driving proficiency relative to the data accessed from the database.

9. The non-transitory computer-readable storage medium of claim 8, wherein measuring a metric of driving proficiency during operation of the motor vehicle comprises continuously measuring the speed of the motor vehicle.

10. The non-transitory computer-readable storage medium of claim 9, wherein accessing a database comprises accessing a geographic information system including speed limit information for a road on which the motor vehicle is travelling while speed is being measured.

11. The non-transitory computer-readable storage medium of claim 8, wherein wirelessly transmitting a report to a remote monitor computing device includes wireless transmitting a report to a remote monitor computing device when an action is taken that would prevent measuring a metric of driving proficiency.

12. The non-transitory computer-readable storage medium of claim 8, wherein wirelessly transmitting a report to a remote monitor computing device includes wirelessly transmitting a report to the remote monitor computing device when an attempt to delete data relating to a measurement of a metric of driving proficiency occurs.

13. The non-transitory computer-readable storage medium of claim 12, wherein the report includes a request to authorize of deny the attempt to delete data.

14. A method of monitoring and analyzing driving proficiency, the method comprising:
(i) measuring a metric related to driving proficiency during operation of a motor vehicle;
(ii) calculating a difference between the measured metric related to driving proficiency and a preset value for the metric related to driving proficiency being measured;
(iii) identifying a driving proficiency violation when the calculated difference exceeds a preset tolerance value for the metric related to driving proficiency being measured; and
(iv) wirelessly transmitting a report including the driving proficiency violation to a remote monitor computing device.

15. The method of claim 14, wherein the method is performed by a user's mobile device while driving or riding in the motor vehicle, and wherein the metric related to driving proficiency is speed, acceleration, deceleration or weaving.

16. The method of claim 14, wherein measuring the at least one metric related to driving proficiency comprises continuously measuring the metric related to driving proficiency during operation of the motor vehicle.

17. The method of claim 14, wherein the preset value for the metric related to driving proficiency being measured is a speed limit, a preset rate of acceleration, a preset rate of deceleration, or a preset number of times a motor vehicle changes lanes over a preset time period or within a preset distance relative to speed.

18. The method of claim 14, wherein:
the metric related to driving proficiency is speed;
the preset value for the metric related to driving proficiency being measured is a government prescribed speed limit;
calculating the difference comprises measuring the difference between the speed at which the motor vehicle is travelling and the speed limit at the location of the motor vehicle at the time the speed is measured; and
wherein the government prescribed speed limit is determined by wirelessly accessing data from a geographic information system including government prescribed speed limit information.

19. The method of claim 14, wherein:
steps (i)-(iii) are performed continuously during a motor vehicle trip; and
step (iv) is performed after the completion of the motor vehicle trip and the report includes any driving proficiency violations that occurred during the motor vehicle trip.
